(19) United States
(12) Patent Application Publication
(10) Pub. No.: US 2024/0291830 A1
(43) Pub. Date: Aug. 29, 2024

(54) DETECTING PORT SCANS IN A CONTAINER ORCHESTRATION SYSTEM CLUSTER

(71) Applicant: VMware LLC, Palo Alto, CA (US)

(72) Inventors: Sergey Kostov, Sofia (BG); Daniel Shapira, Ramat Gan (IL)

(21) Appl. No.: 18/115,722

(22) Filed: Feb. 28, 2023

(51) Int. Cl. H04L 9/40

(52) U.S. Cl. CPC H04L 63/1416; H04L 63/1425

(57) ABSTRACT

Some embodiments of the invention provide a method for detecting port scans in a container orchestration system cluster that includes at least a first machine executing on a host computer. The method identifies a packet stream between the first machine and a second machine operating outside of the host computer. The method determines that the packet stream is potentially part of a port scanning operation based on an assessment that the packet stream includes less than a threshold number of packets during a particular time period. Based on said determination, the method identifies an amount of payload data exchanged between the first and second machines in the packet stream during the particular time period. When the identified amount of payload data is less than or equal to a threshold amount of payload data, the method classifies the stream as a probable port-scanning stream.

### BACKGROUND

Today, port scan detection algorithms operate in environments where crucial information is missing, such as TCP flags and IP header information. Because of this, it can be impossible to identify the initiator of a connection, and almost impossible to identify who is the client and who is the server. Additionally, it is always impossible to identify if it is a freshly discovered connection or an existing connection. An algorithm that overcomes these limitations is not presently available.

### BRIEF SUMMARY

Some embodiments of the invention provide a method for detecting port scans in a container orchestration system cluster (e.g. a Kubernetes® cluster) that includes at least a first machine executing on a host computer. The first machine, in some embodiments, is a first pod that executes on a node (e.g., a virtual machine (VM)) executing on the host computer. In some embodiments, the method is performed by a user-space program (referred to below as a port scan detection program or sensor program) that is deployed to the node (e.g., the VM) and runs as a daemon set that monitors all network traffic on the node. For every interface (e.g., a VNIC (virtual network interface card) of the VM), two packet filter (e.g., eBPF (Berkeley Packet Filter)) programs are attached as TC_CLS (traffic control cumulative layout shift) filters for incoming and outgoing traffic (i.e., one packet filter for incoming and one packet filter for outgoing). The sensor program, in some embodiments, operates at the lowest possible packet level (e.g., layer 2 (L2)) in the network stack of the interface.

To identify port scan operations, the method of some embodiments first identifies a packet stream between the first machine and a second machine that operates outside of the host computer. Based on an assessment that the packet stream includes less than a threshold number of packets during a particular time period, the method determines that the packet stream is potentially part of a port scanning operation. Based on said determination, the method identifies an amount of payload data exchanged between the first and second machines in the packet stream during the particular time period, and when the identified amount of payload data is less than or equal to a threshold amount of payload data, the method classifies the stream as a probable port-scanning stream.

In some embodiments, the sensor program identifies the packet stream by identifying a set of packet stream data for the packet stream and to which packets belonging to the packet stream are mapped. The set of packet stream data is identified, in some embodiments, by selecting the set of packet stream data from multiple sets of packet stream data that each correspond to a different packet stream associated with the first machine. In some embodiments, the sensor program selects the set of packet stream data as part of a periodic walkthrough of the multiple sets of packet stream data to identify potential port scan operations.

The set of packet stream data, in some embodiments, includes at least a first IP (Internet Protocol) address and a first port number associated with the first machine, a second IP address and a second port number associated with the second machine, and the amount of payload data exchanged between the first and second machines. As such, the amount of payload data exchanged between the first and second machines is identified from the set of packet stream data for the packet stream. In some embodiments, the set of packet stream data includes additional information that is not used by the sensor program during its port scan detection operations.

In some embodiments, the threshold number of packets used in determining that the packet stream is potentially part of a port scanning operation is a threshold number of packets exchanged in each direction, and the assessment that the packet stream includes less than the threshold number of packets during the particular time period is an assessment that the packet stream includes less the threshold number of packets exchanged in each direction during the particular time period. The determination that the packet stream is part of a port scanning operation based on the assessment, in some embodiments, is also a determination that the packet stream is an invalid packet stream.

The threshold amount of payload data exchanged between the first and second machines in the packet stream during the particular time period is a threshold amount of bytes exchanged between the first and second machines in the packet stream in each direction during the particular time period. In some embodiments, when the amount of bytes sent by the first machine is more than the threshold amount of bytes and the amount of bytes sent by the second machine is less than or equal to the threshold amount of bytes, the stream is classified as a probable port-scanning stream. The threshold amount of bytes, in some embodiments, is zero bytes (i.e., as long as each of the first and second machines exchanges more than zero bytes, the packet stream is not considered a port scanning operation). When the identified amount of payload data exchanged between the first and second machines in the packet stream is greater than the threshold amount of payload data (e.g., greater than zero bytes), the stream is not classified as a probable port-scanning stream, according to some embodiments.

In some embodiments, before classifying the stream as a probable port-scanning stream, the sensor program determines whether the probable port-scanning stream is a probable internal port-scanning stream or a probable egress port-scanning stream. If an IP address of the second machine (1) has made more than a specified threshold number of connections to private IP addresses that are within a range of IP addresses allocated for the container orchestration system cluster or (2) is within the range of IP addresses allocated for the container orchestration system cluster, the packet stream is classified as a probable internal port-scanning stream, in some embodiments. Otherwise, the packet stream is classified as a probable egress port-scanning stream, according to some embodiments.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF FIGURES

The novel features of the invention are set forth in the appended claims. However, for purposes of explanation, several embodiments of the invention are set forth in the following figures.

FIG. 1 conceptually illustrates a block diagram showing a packet stream between pods on different host computers, in some embodiments.

FIG. 2 conceptually illustrates another block diagram showing a packet stream between a host computer and a machine external to the host computer and a network in which the host computer resides, in some embodiments.

FIG. 3, which conceptually illustrates a process of some embodiments for identifying and classifying port scans or probable port scans.

FIG. 4 illustrates an example of the structure of network events generated each time a packet traverses the interface, in some embodiments.

FIG. 5 illustrates an example of a stream structure of some embodiments.

FIG. 6 illustrates an example of a stream descriptor of some embodiments.

FIG. 7 conceptually illustrates a block diagram of the sensor and its functions, according to some embodiments.

FIG. 8 illustrates an example of the walkthrough performed by the stream validator 740, in some embodiments.

FIG. 9 illustrates an example of some embodiments showing how the stream validator determines whether a stream is valid or invalid.

FIG. 10 illustrates an example showing how the size analyzer determines whether a stream is a port scan stream or probable port scan stream, in some embodiments.

FIG. 11 illustrates an example of a mapPortScanStream function, in some embodiments.

FIG. 12 illustrates an example of pseudocode for this function, in some embodiments.

FIG. 13 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a method for detecting port scans and probable port scans in a container orchestration system (e.g., Kubernetes®) cluster. A user-space program (referred to below as a port scan detection program or sensor program) is deployed to a node (e.g., a virtual machine (VM)), such as a worker node or master node in the container orchestration system cluster, and runs as a daemon set that monitors all network traffic on the node. For every interface (e.g., a VNIC (virtual network interface card) of a VM), two packet filter (e.g., eBPF (Berkeley Packet Filter)) programs are attached as TC_CLS (traffic control cumulative layout shift) filters for incoming and outgoing traffic (i.e., one packet filter for incoming and one packet filter for outgoing). The sensor program, in some embodiments, operates at the lowest possible packet level (e.g., layer 2 (L2)) in the network stack of the interface.

In some embodiments, each packet is processed and translated into a custom structure that represents the source and destination of the packet in terms of direction according to the interface SELF_IP and OTHER_IP, where the SELF_IP is the IP address that is local for the interface and OTHER_TP is the IP address that is not local for the interface, as well as for SELF_PORT and OTHER_PORT. The translated structure is then fed, in some embodiments, to the sensor program for processing using a generic data structure for storage of different data types (e.g., eBPF maps). Within the sensor program, a port scan detection process takes place to identify and report port scans or probable port scans. The port scan detection process, in some embodiments, is an algorithm or series of algorithms that is/are protocol independent, heuristic algorithm(s) that can reliably detect a port scan. In some embodiments, only IPv4 (Internet Protocol version 4) and TCP (transmission control protocol) packets are processed by the sensor program.

To identify port scan operations, the method of some embodiments first identifies a packet stream between the first machine and a second machine that operates outside of the host computer. Based on an assessment that the packet stream includes less than a threshold number of packets during a particular time period, the method determines that the packet stream is potentially part of a port scanning operation. Based on said determination, the method identifies an amount of payload data exchanged between the first and second machines in the packet stream during the particular time period, and when the identified amount of payload data is less than or equal to a threshold amount of payload data, the method classifies the stream as a probable port-scanning stream.

In some embodiments, the sensor program identifies the packet stream by identifying a set of packet stream data for the packet stream and to which packets belonging to the packet stream are mapped. The set of packet stream data is identified, in some embodiments, by selecting the set of packet stream data from multiple sets of packet stream data that each correspond to a different packet stream associated with the first machine. In some embodiments, the sensor program selects the set of packet stream data as part of a periodic walkthrough of the multiple sets of packet stream data to identify potential port scan operations.

The set of packet stream data, in some embodiments, includes at least a first IP (Internet Protocol) address and a first port number associated with the first machine, a second IP address and a second port number associated with the second machine, and the amount of payload data exchanged between the first and second machines. As such, the amount of payload data exchanged between the first and second machines is identified from the set of packet stream data for the packet stream. In some embodiments, the set of packet stream data includes additional information that is not used by the sensor program during its port scan detection operations.

In some embodiments, the threshold number of packets used in determining that the packet stream is potentially part of a port scanning operation is a threshold number of packets exchanged in each direction, and the assessment that the packet stream includes less than the threshold number of packets during the particular time period is an assessment that the packet stream includes less the threshold number of packets exchanged in each direction during the particular time period. The determination that the packet stream is part of a port scanning operation based on the assessment, in some embodiments, is also a determination that the packet stream is an invalid packet stream.

The threshold amount of payload data exchanged between the first and second machines in the packet stream during the particular time period is a threshold amount of bytes exchanged between the first and second machines in the packet stream in each direction during the particular time period. In some embodiments, when the amount of bytes sent by the first machine is more than the threshold amount of bytes and the amount of bytes sent by the second machine is less than or equal to the threshold amount of bytes, the stream is classified as a probable port-scanning stream. The threshold amount of bytes, in some embodiments, is zero bytes (i.e., as long as each of the first and second machines exchanges more than zero bytes, the packet stream is not considered a port scanning operation). When the identified amount of payload data exchanged between the first and second machines in the packet stream is greater than the threshold amount of payload data (e.g., greater than zero bytes), the stream is not classified as a probable port-scanning stream, according to some embodiments.

In some embodiments, before classifying the stream as a probable port-scanning stream, the sensor program determines whether the probable port-scanning stream is a probable internal port-scanning stream or a probable egress port-scanning stream. If an IP address of the second machine (1) has made more than a specified threshold number of connections to private IP addresses that are within a range of IP addresses allocated for the container orchestration system cluster or (2) is within the range of IP addresses allocated for the container orchestration system cluster, the packet stream is classified as a probable internal port-scanning stream, in some embodiments. Otherwise, the packet stream is classified as a probable egress port-scanning stream, according to some embodiments.

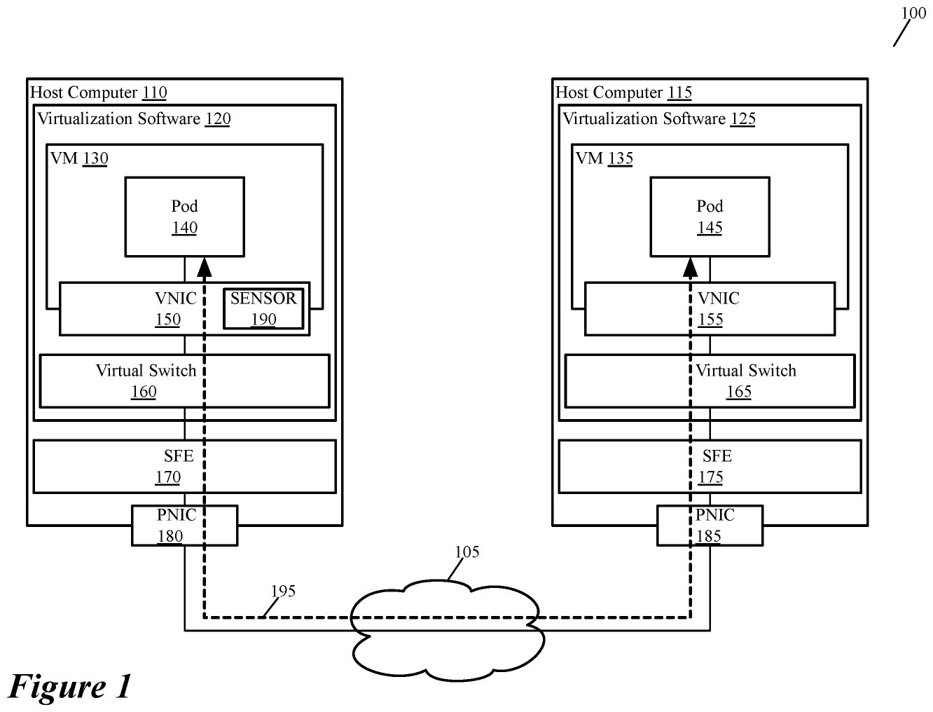

FIG. 1 conceptually illustrates a block diagram 100 showing a packet stream between pods on different host computers, in some embodiments. As illustrated, the block diagram 100 includes host computers 110 and 115. Each of the host computers 110 and 115 includes virtualization software 120 and 125 (e.g., hypervisors), an SFE 170 and 175, and a PNIC 180 and 185. The virtualization software 120 and 125 of each of the host computers 110 and 115 includes a virtual switch 160 and 165, and a VM 130 and 135 on which a pod 140 and 145 runs. The virtual switches 160 and 165 forward data packets between the SFEs 170 and 175 and the VNICs 150 and 155, respectively. Additionally, the VNIC 150 includes the sensor program 190 for performing port scan detection as described above.

While illustrated as part of the VNIC 150, the sensor 190 in other embodiments operates outside of the VNIC 150 of the VM 130 and on the host computer 110, such as part of the virtualization software's 120 service (i.e., the virtualization software over which the VM 130 executes). In still other embodiments, the sensor 190 operates on the same VM 130 on which the pod 140 operates but outside of the VNIC 150.

Traffic, such as the stream 195 represented by the dotted line, between the host computers 110 and 115 traverses an intervening network 105. In some embodiments, the intervening network includes a private network, such as an MPLS (multiprotocol label switching) network. In other embodiments, the intervening network includes one or more public networks, such as the Internet and/or one or more networks of one or more public clouds. In still other embodiments, the intervening network includes a combination of public and private networks (such as those mentioned above).

Each VNIC 150 and 155 is responsible for exchanging messages between its VM 130 and 135 and the SFE 170 and 175. In some embodiments, each of the VMs 130 and 135 is one of multiple VMs executing in the virtualization software 120 and 125 on the host computers 110 and 115, with each VM having its own respective VNIC for exchanging data messages between their VMs and respective virtual switches 160 and 165. In some such embodiments, each VNIC connects to a particular interface of the virtual switch 160 and 165. Each virtual switch 160 and 165 also connects to a respective SFEs 170 and 175, which also connects to a respective physical network interface card (PNIC) 180 and 185 of the host computers 110 and 115. In some embodiments, the VNICs are software abstractions created by the virtualization software 120 and 125 of one or more PNICs 180 and 185 of the hosts.

Each SFE 170 and 175 connects to the respective host PNIC 180 and 185 (through a NIC driver [not shown]) to send outgoing messages and to receive incoming messages. In some embodiments, each SFE 170 and 175 is defined to include a port (not shown) that connects to the PNIC's driver to send and receive messages to and from the PNIC. Each SFE 170 and 175 performs message-processing operations to forward messages that it receives on one of its ports to another one of its ports. For example, in some embodiments, each SFE 170 and 175 tries to use data in the message (e.g., data in the message header) to match a message to flow-based rules, and upon finding a match, to perform the action specified by the matching rule (e.g., to hand the message to one of its ports which directs the message to be supplied to a destination VM via the virtual switch 160 and 165 or to the PNIC 180 and 185).

In some embodiments, each SFE 170 and 175 is a software switch, while in other embodiments it is a software router or a combined software switch/router. Each SFE 170 and 175, in some embodiments, implements one or more logical forwarding elements (e.g., logical switches or logical routers) with SFEs executing on other hosts in a multi-host environment. A logical forwarding element, in some embodiments, can span multiple hosts to connect DCNs (e.g., VMs, containers, pods, etc.) that execute on different hosts but belong to one logical network. Similarly, each virtual switch 160 and 165 of some embodiments spans multiple host computers to connect DCNs belonging to the same logical network, as well as DCNs belonging to various different subnets (e.g., to connect DCNs belonging to one subnet to DCNs belonging to a different subnet).

Different logical forwarding elements can be defined to specify different logical networks for different users, and each logical forwarding element can be defined by multiple software forwarding elements on multiple hosts. In some embodiments, for instance, each virtual switch 160 and 165 is defined by a respective SFE 170 and 175. Each logical forwarding element isolates the traffic of the DCNs of one logical network from the DCNs of another logical network that is serviced by another logical forwarding element. A logical forwarding element can connect DCNs executing on the same host and/or different hosts, both within a datacenter and across datacenters. In some embodiments, the SFEs 170 and 175 and the virtual switches 160 and 165 extract from a data message a logical network identifier (e.g., a VNI) and a MAC address. The SFEs 170 and 175 and virtual switches 160 and 165 in these embodiments use the extracted VNI to identify a logical port group, and then uses the MAC address to identify a port within the port group.

The virtualization software 120 and 125 (e.g., hypervisors) serve as interfaces between VMs 130 and 135 and the SFEs 170 and 175, in some embodiments, as well as other physical resources (e.g., CPUs, memory, etc.) available on host computers 110 and 115, in some embodiments. The architecture of the virtualization software 120 and 125 may vary across different embodiments of the invention. In some embodiments, the virtualization software 120 and 125 can be installed as system-level software directly on the host computers 110 and 115 (i.e., a “bare metal” installation) and be conceptually interposed between the physical hardware and the guest operating systems executing in the VMs. In other embodiments, the virtualization software 120 and 125 may conceptually run “on top of” a conventional host operating system in the server.

In some embodiments, the virtualization software 120 and 125 include both system-level software and a privileged VM (not shown) configured to have access to the physical hardware resources (e.g., CPUs, physical interfaces, etc.) of the host computers 110 and 115. While the VNICs 150 and 155 is shown as included in the VMs 130 and 135, the VNICs 150 and 155 in other embodiments is implemented by the code (e.g., VM monitor code) of the virtualization software 120 and 125. In still other embodiments, the VNICs 150 and 155 are partly implemented in their associated VMs and partly implemented by the virtualization software executing on their VM's host computer. In some embodiments, the VNICs 150 and 155 are a software implementation of a physical NIC. In some of these embodiments, the VNICs serve as the virtual interface that connect their VMs to a virtual forwarding element (e.g., the virtual switches 160 and 165), in the same manner that a PNIC serves as the physical interface through which a physical compute connects to a physical forwarding element (e.g., a physical switch). The virtual switches 160 and 165 are connected to the SFEs 170 and 175, which connect to the PNICs 180 and 185, in order to allow network traffic to be exchanged between elements (e.g., the VMs 130 and 135) executing on host computers 110 and 115 and destinations on an external physical network.

In some embodiments, each Pod 140 and 145 is a small deployable unit of computing that can be created and managed in Kubernetes®. A Pod includes a group of one or more containers with shared storage and network resources, and a specification for how to run the containers. In some embodiments, a Pod's contents are always co-located and co-scheduled, and run in a shared context. A Pod models an application-specific logical host computer; it contains one or more application containers that are communicate with each other. In some embodiments, the shared context of a Pod is a set of an operating system namespaces (e.g., Linux cgroups). Within a Pod's context, the individual applications may have further sub-isolations applied.

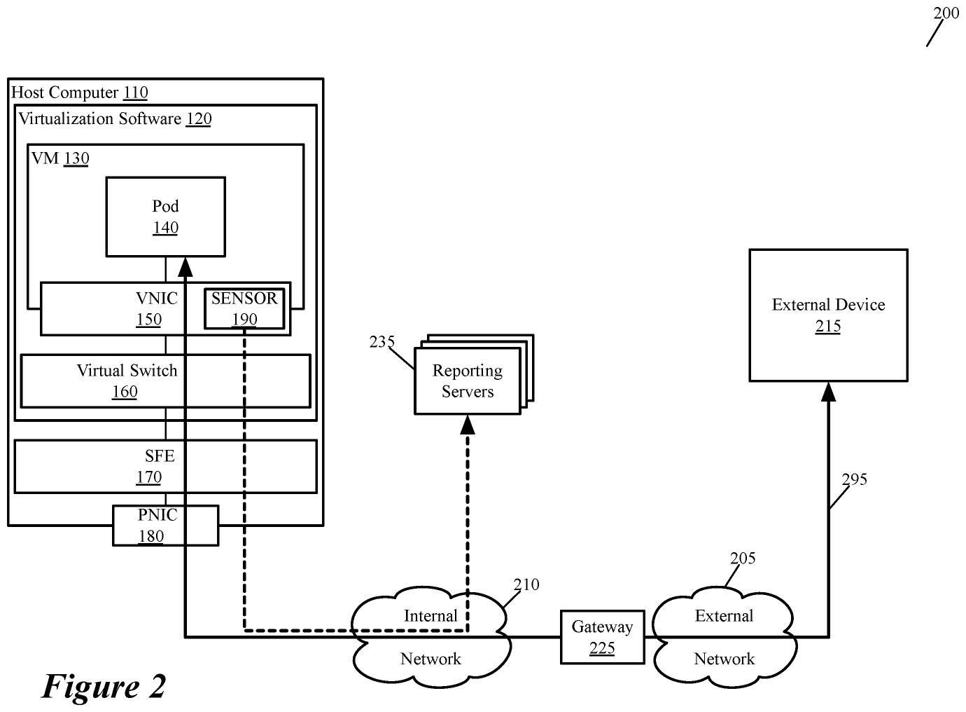

FIG. 2 conceptually illustrates another block diagram showing a packet stream between a host computer and a machine external to the host computer and a network in which the host computer resides, in some embodiments. As shown, the diagram 200 includes the host computer 110 described above as well as a set of reporting servers 235 to which the sensor 190 sends reports regarding detected port scans and probable port scans through an internal network 210, and an external device 215 that is reachable through a gateway 225 and external network 205.

In some embodiments, as the sensor 190 detects port scans and probable port scans, the sensor 190 notifies a local agent (not shown) on the host computer 110 of the detected port scans and probable port scans. The local agent of some embodiments is a local control plane agent and the reporting servers are a central control plane server or cluster of servers, according to some embodiments. In some embodiments, based on the notification from the sensor 190 that a stream has been detected and classified as a port scan or probable port scan, the local agent generates and sends a report identifying the detected port scans and probable port scans to an external server(s), such as the reporting servers 235, via the internal network 210 (e.g., container network). The local agent of some embodiments generates the report from a database, and subsequently stores the report in the database.

In some embodiments, responsive to the report from the local agent, the reporting servers 235 generate an alert themselves and, in some embodiments, take actions based on the report. In other embodiments, the reporting servers 235 pass the report to a management plane (not shown), which takes actions based on the report, or directs the reporting servers (e.g., central control plane cluster) to take certain actions based on the report.

Examples of actions taken by the management plane and/or reporting servers 235 (e.g., central control plane servers), in some embodiments, include proactively generating and sending an alert electronically (e.g., via e-mail, SMS, machine-generated automated phone call, etc.), adding the network address information (e.g., “OTHER_IP” and “OTHER_PORT”) for the external device 215 with which the port scan or probable port scan stream is associated to a list of potential bad actors (e.g., a blacklist), defining a firewall rule to drop packets associated with the external device 215, defining a firewall rule or other forwarding rule to redirect packets associated with the external device 215.

In some embodiments, examples of firewall rules or other forwarding rules defined to redirect packets associated with the external device 215 include a rule for redirecting packets associated with the external device 215 to a security environment (e.g., an isolated environment such as a sandbox) implemented by one or more machines to process the flows from the offending external device 215 with additional security constraints, or a rule for redirecting packets associated with the external device 215 to one or more security machines or appliances that perform one or more security operations, such as a machine that performs DPI (deep packet inspection), including L7 firewall and L7 security operations (e.g., intrusion detection and/or intrusion prevention operations), a machine that performs intrusion detection, or a machine that performs intrusion prevention.

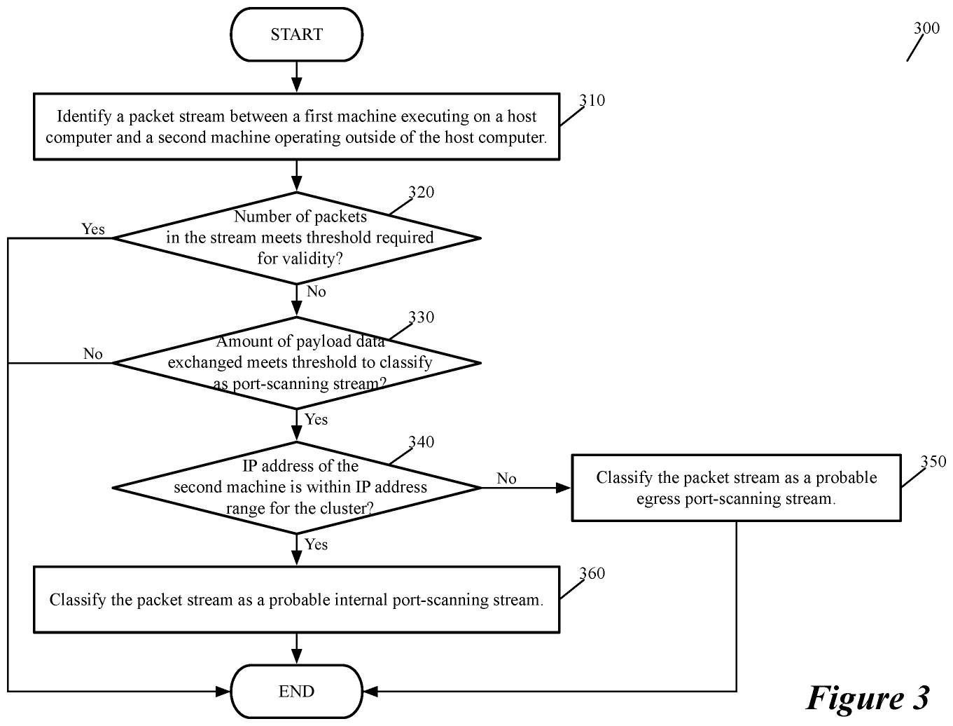

FIG. 1 will be further described below by reference to FIG. 3, which conceptually illustrates a process 300 of some embodiments for identifying and classifying port scans or probable port scans. The process 300 is performed by a sensor program (e.g., the sensor 190), in some embodiments.

The process 300 starts when the sensor program identifies (at 310) a packet stream between a first machine executing on a host computer and a second machine operating outside of the host computer. The first and second machines, in some embodiments are VMs, while in other embodiments, the first and second machines are pods or containers. For instance, in the block diagram 100, the stream 195 is between pods 140 and 145.

In some embodiments, the sensor program maintains a map of packet streams, with each stream map holding information about the stream, and the sensor program identifies the packet stream by selecting the packet stream as part of a periodic walk-through of the stream maps. In some embodiments, the stream maps are records that each include a set of data associated with packets of the corresponding packet stream. Each record or stream map, in some embodiments, has (1) a stream identifier (e.g., L2-L4 header values that identify the stream in one or both directions) and (2) a set of one or more fields for storing one or more cumulated statistics (e.g., packet count, byte count, etc.) associated with the stream.

More specifically, in some embodiments, the information included with the stream map, in some embodiments, includes at least IP addresses and ports of the first and second machines, as well as a number of bytes exchanged between the first and second machines. For example, for the stream 195, the stream map would include IP addresses and port numbers for the pods 140 and 145, and an amount of bytes exchanged between the pods 140 and 145.

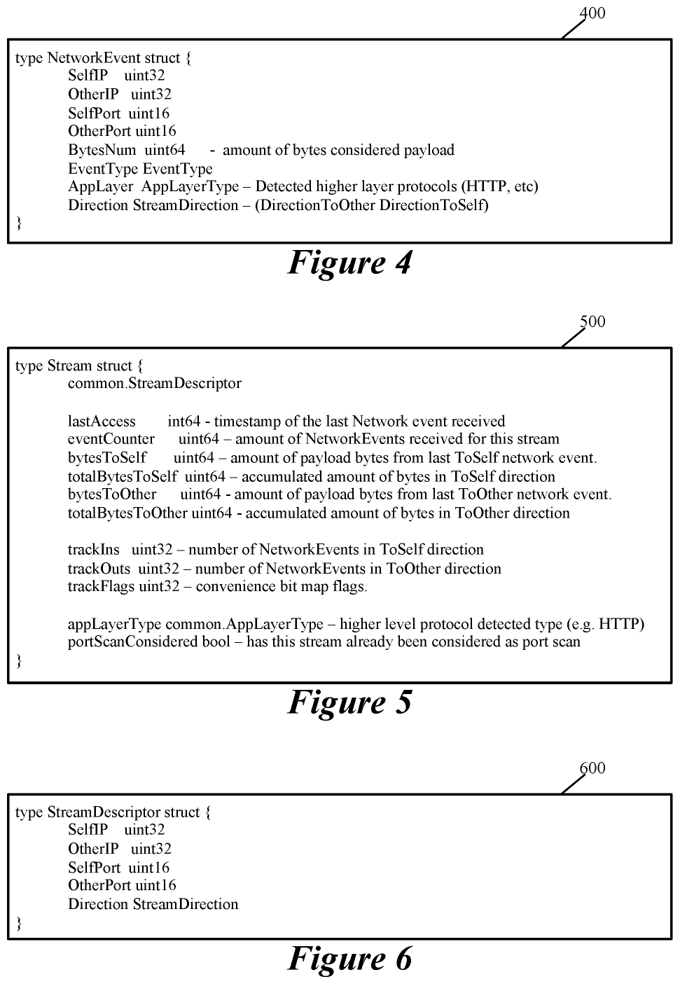

FIG. 4 illustrates an example 400 of the structure of network events generated each time a packet traverses the interface, in some embodiments. As shown, the structure includes SelfIP (i.e., the IP address of the machine with which the interface is associated), OtherIP (i.e., the IP address of the other machine associated with the stream), SelfPort (i.e., the port number of the machine with which the interface is associated), OtherPort (i.e., the port number of the other machine associated with the stream), BytesNum (i.e., the amount of bytes in the packet's payload), EventType (i.e., an indication of whether the event is initializing/closing the connection or transmitting data), AppLayer and AppLayerType (i.e., detected higher layer protocols such as HTTP), and Direction (i.e., direction of the packet expressed as “DirectionToOther” or “DirectionToSelf”).

In the example 400, the fields that are relevant to the port scan detection program are SelfIP, OtherIP, SelfPort, OtherPort, and BytesNum, according to some embodiments. The EventType, in the context of the example 400, in some embodiments, is a best-effort attempt to annotate whether the event is related to the initialization or closing of a connection, or transmission of data using the connection. Examples of event types, in some embodiments, include EventTypeInit, EventTypeClose, and EventTypeData. While the event type is not crucial for the port scan detection program, this data allows for certain speed optimizations, in some embodiments.

The data from the network events, in some embodiments, is used to create stream maps. For example, FIG. 5 illustrates an example 500 of a stream structure of some embodiments. As shown, the stream structure includes a stream descriptor, a timestamp of the last network event received, an amount of network events received for the stream, an amount of payload data in bytes from the last ToSelf network event, an accumulated amount of bytes in the ToSelf direction, an amount of payload data in bytes from the last ToOther network event, an accumulated amount of bytes in the ToOther direction, a number of network events in the ToSelf direction, a number of network events in the ToOther direction, tracked bit map flags, types of detected higher level protocols (e.g., HTTP), and whether the stream has already been considered as a port scan stream.

In addition to the stream structure illustrated by the example 500, each stream is also associated with a stream descriptor. For example, FIG. 6 illustrates an example 600 of a stream descriptor of some embodiments. As shown, the stream descriptor includes the IP addresses and port numbers of each machine (i.e., designated by “Self” or “Other”), as well as a direction of the stream. In some embodiments, the key for the stream map is the tuple SelfIP, OtherIP, SelfPort, OtherPort.

Returning to the process 300, the process 300 determines (at 320) whether a number of packets in the packet stream meets a threshold number of packets exchanged during a specified time period required for the packet stream to be a valid packet stream. As packets belonging to the stream traverse the interface in which the sensor program is implemented, information from the packets is extracted and mapped to the stream. That is, the record created to store packet stream data (e.g., packet stream statistics) is iteratively updated as new packets belonging to the packet stream are received and sent in order to update the statistics stored in the record. In some embodiments, each packet belonging to the stream is mapped to the record or stream map for the packet stream by matching a set of header values from the packet to the corresponding record.

As described above, the stream map includes data such as the number of packets belonging to the stream (i.e., the amounts of network events received for the stream in either direction), and, based on a start time of the connection between the first and second machines, the number of packets sent within the specified time period can be determined. In some embodiments, the threshold number of packets exchanged is three (3) packets exchanged in either direction (i.e., each machine has sent three packets and received three packets).

Packet streams determined to be invalid packet streams, in some embodiments, are packet streams that are potentially associated with port scans, while packet streams determined to be valid are not suspected as port scan streams, according to some embodiments. Accordingly, when the number of packets in the stream meets the threshold number of packets exchanged during the specified time period (i.e., the packet stream is determined to be a valid packet stream), the process 300 ends.

Otherwise, when the number of packets in the stream is below the threshold number of packets exchanged during the specified time period, the process 300 transitions to determine (at 330) whether an amount of payload data exchanged between the first and second machines within the specified time period meets a threshold amount of data exchanged to classify the stream as a probable port-scanning stream.

This threshold, in some embodiments, is a threshold number of bytes exchanged in each direction (i.e., “ToSelf” and “ToOther”). Thus, if one machine has sent packets and exceeded the threshold number of bytes, while the other machine has sent packets and not exceeded the threshold number of bytes, the stream would be classified as a probable port scanning stream, in some embodiments. The threshold, in some embodiments, is zero (0) bytes (i.e., each machine must send more than zero bytes for the stream to not be a suspected or probable port scanning stream).

When the amount of payload data exchanged exceeds the threshold (i.e., more than the threshold number of bytes have been exchanged in both directions), the process 300 ends. Otherwise, when the amount of payload data exchanged is less than or equal to the threshold (e.g., zero bytes exchanged from at least one machine), the process 300 transitions to determine (at 340) whether the IP address of the second machine (i.e., the “other” machine) is within a range of IP addresses assigned to cluster. That is, the sensor program 190 determines whether the pod 145 belongs to the same cluster as the pod 140.

When the IP address of the second machine is not within the range of IP addresses assigned to the cluster, the process 300 transitions to classify (at 350) the packet stream as a probable egress port-scanning stream. That is, due to the IP address of the second machine being out of the cluster's range of IP addresses, the process determines that the second machine is external to the cluster, and thus the probable port-scanning attempt is an egress port scanning attempt that originates externally to the cluster. Following 350, the process 300 ends. Otherwise, when the IP address of the second machine is within the range of IP addresses assigned to the cluster, the process 300 transitions to classify (at 360) the stream as a probable internal port-scanning stream. Following 360, the process 300 ends.

It should be noted that while the embodiments described above and below rely on criteria such as number of packets exchanged and amount of payload data exchanged, other embodiments account for other criteria as well. For example, in some other embodiments, the sensor 190 not only monitors flow from the “OTHER_IP”/“OTHER_PORT” for one port, but also monitors that the “OTHER_IP”/“OTHER_PORT” has been sending multiple streams to the “SELF_IP” that are directed to different destination L4 ports, and all of these streams have no or little payload.

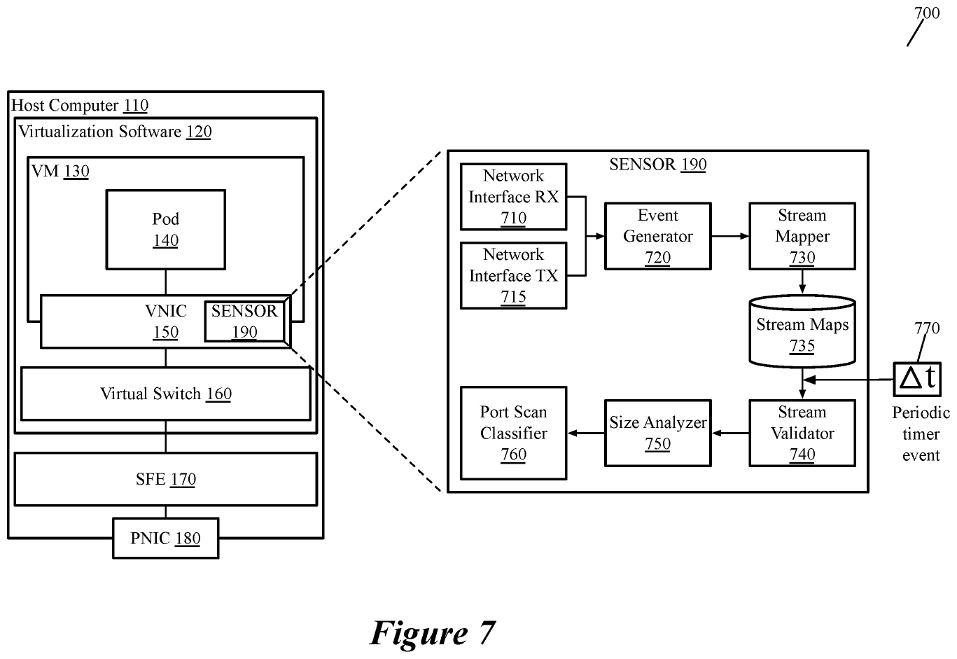

The sensor 190, in some embodiments, executes various functions in performing the process 300 described above. FIG. 7 conceptually illustrates a block diagram 700 of the sensor 190 and its functions, according to some embodiments. As shown, the sensor 190 includes a network interface RX 710, a network interface TX 715, an event generator 720, a stream mapper 730, a stream maps storage 735, a stream validator 740, a size analyzer 750, and a port scan classifier 760.

The network interface RX 710, in some embodiments, detects the volume of data in bytes received by the interface (i.e., the VNIC 150), while the network interface TX 715, in some embodiments, detects the number of point-to-point communications transmitted by the interface (i.e., the VNIC 150). The event generator 720, in some embodiments, uses the information from the network interface RX 710 and the network interface TX 715 to generate network events for packets that traverse the VNIC 150 according to the structure illustrated in the example 400 described above.

The event generator 720 provides the generated events to the stream mapper 730, which determines whether the generated events correspond to an existing stream map in the stream maps storage 735, or whether the generated events correspond to new streams. Based on this determination, the stream mapper 730 either maps the generated events to their corresponding streams in the stream maps storage 735, or creates new streams in the stream maps storage 735 when the network event is not associated with an existing stream.

The stream validator 740, in some embodiments, does a periodic walkthrough of all of the streams stored in the stream maps storage 735 to identify any invalid streams (i.e., any potential port scanning streams) that should be processed by the size analyzer 750. In some embodiments, the stream validator 740 performs the walkthrough based on the periodic timer event 770. Each stream determined to be invalid and thus a potential port scanning stream is then provided to the size analyzer 750 for further analysis.

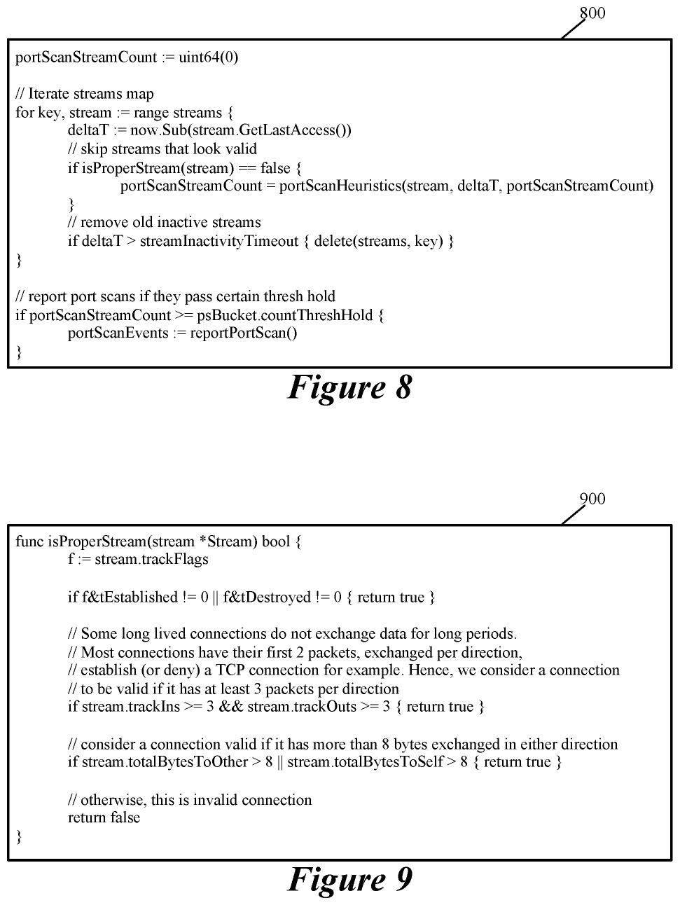

In some embodiments, the stream validator 740 also removes inactive streams from the stream maps storage 735 during its periodic walkthroughs of the streams. FIG. 8 illustrates an example 800 of the walkthrough performed by the stream validator 740, in some embodiments. As shown, the stream validator 740 skips streams that appear valid, identifies invalid streams for which further analysis should be performed, and removes inactive streams.

FIG. 9 illustrates an example 900 of some embodiments showing how the stream validator 740 determines whether a stream is valid or invalid. As shown, the stream validator 740 relies on the data included in the stream map (e.g., as described above for the stream structure example 500), and if a connection has exchanged at least three packets in each direction, the stream is considered valid.

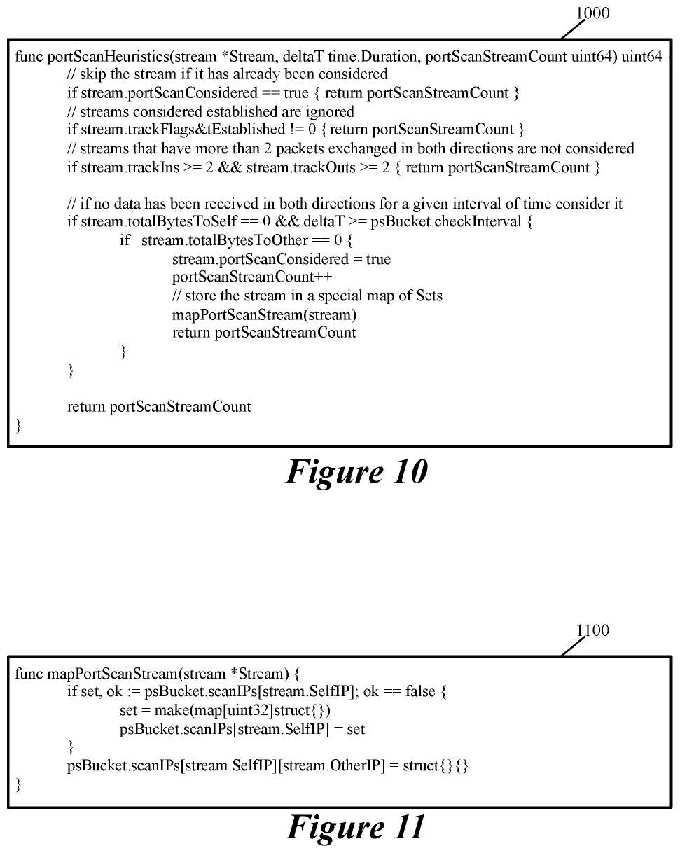

The size analyzer 750 receives the invalid streams from the stream validator 740 and determines whether the amount of payload data (in bytes) exchanged in each direction meets or exceeds the threshold number of bytes. FIG. 10 illustrates an example 1000 showing how the size analyzer 750 determines whether a stream is a port scan stream or probable port scan stream, in some embodiments. As shown, the size analyzer 750 relies on various data from the stream structure 500, such as the bytes exchanged in each direction, the tracked flags, packets exchanged, etc. If the amount of bytes exchanged is less than or equal to the threshold, the stream is classified as a port scan stream or probable port scan stream.

The streams determined to be port scan streams are then provided to the port scan classifier 760, which determines whether the port scan is an internal port scan or an egress port scan. In some embodiments, the port scan classifier 760 relies on a mapPortScanStream function that, in some embodiments, plays a crucial role in organizing the data in a way that makes classifying the port scan as internal or egress easier as this function maintains a map of sets such that for each stream.SelfIP, a Set of stream.OtherIP is maintained. FIG. 11 illustrates an example 1100 of this function, in some embodiments.

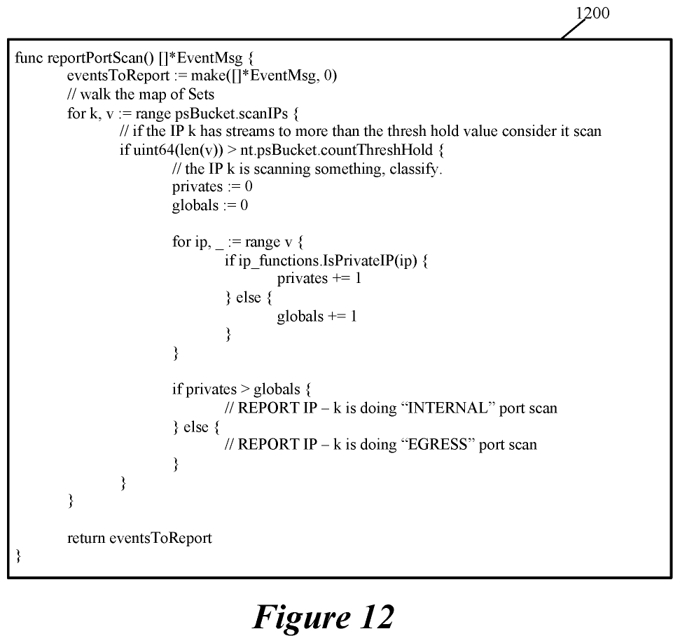

In some embodiments, if an IP address has made more than specified threshold number of connections to a private IP address range or is internal for the container network IP addresses, then the stream is considered “INTERNAL”. Otherwise, the stream is considered “EGRESS”. FIG. 12 illustrates an example 1200 of pseudocode for this function, in some embodiments.

While the embodiments described above include analyses done based on data (e.g., statistics) for bi-directional streams between a “SELF_IP”/“SELF_PORT” and an “OTHER_IP”/“OTHER_PORT”, it should be noted that other embodiments only perform the assessment based on streams (e.g., flows) received from the “OTHER_IP”/“OTHER_PORT”, and not the responsive stream sent from the “SELF_IP”/“SELF_PORT” to the “OTHER_IP”/“OTHER_PORT”. Also, it should be noted that the port scanning sensor (e.g., sensor 190) of some embodiments is used for VMs that do not have pods or containers running on them.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

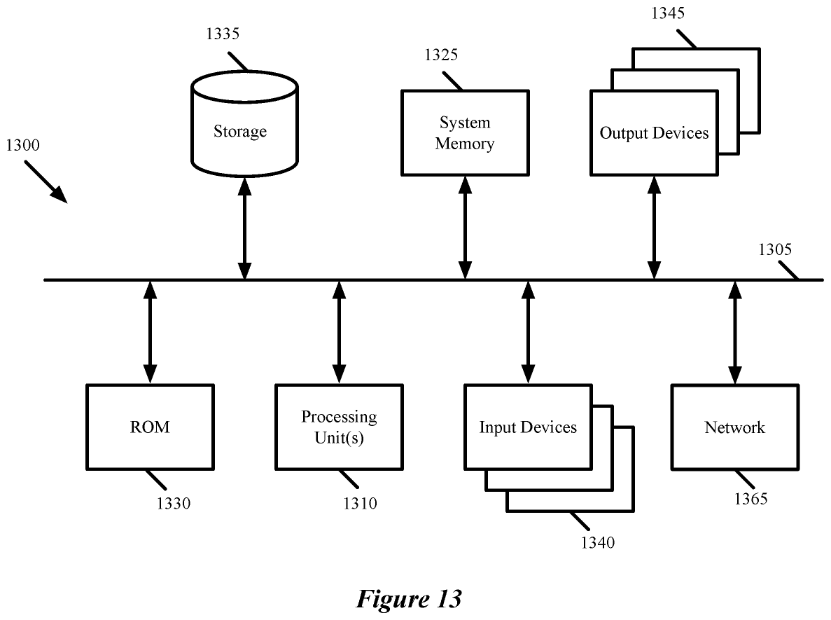

FIG. 13 conceptually illustrates a computer system 1300 with which some embodiments of the invention are implemented. The computer system 1300 can be used to implement any of the above-described hosts, controllers, gateway, and edge forwarding elements. As such, it can be used to execute any of the above described processes. This computer system 1300 includes various types of non-transitory machine-readable media and interfaces for various other types of machine-readable media. Computer system 1300 includes a bus 1305, processing unit(s) 1310, a system memory 1325, a read-only memory 1330, a permanent storage device 1335, input devices 1340, and output devices 1345.

The bus 1305 collectively represents all system, peripheral, and chipset buses that communicatively connect the numerous internal devices of the computer system 1300. For instance, the bus 1305 communicatively connects the processing unit(s) 1310 with the read-only memory 1330, the system memory 1325, and the permanent storage device 1335.

From these various memory units, the processing unit(s) 1310 retrieve instructions to execute and data to process in order to execute the processes of the invention. The processing unit(s) 1310 may be a single processor or a multi-core processor in different embodiments. The read-only-memory (ROM) 1330 stores static data and instructions that are needed by the processing unit(s) 1310 and other modules of the computer system 1300. The permanent storage device 1335, on the other hand, is a read-and-write memory device. This device 1335 is a non-volatile memory unit that stores instructions and data even when the computer system 1300 is off. Some embodiments of the invention use a mass-storage device (such as a magnetic or optical disk and its corresponding disk drive) as the permanent storage device 1335.

Other embodiments use a removable storage device (such as a floppy disk, flash drive, etc.) as the permanent storage device. Like the permanent storage device 1335, the system memory 1325 is a read-and-write memory device. However, unlike storage device 1335, the system memory 1325 is a volatile read-and-write memory, such as random access memory. The system memory 1325 stores some of the instructions and data that the processor needs at runtime. In some embodiments, the invention's processes are stored in the system memory 1325, the permanent storage device 1335, and/or the read-only memory 1330. From these various memory units, the processing unit(s) 1310 retrieve instructions to execute and data to process in order to execute the processes of some embodiments.

The bus 1305 also connects to the input and output devices 1340 and 1345. The input devices 1340 enable the user to communicate information and select commands to the computer system 1300. The input devices 1340 include alphanumeric keyboards and pointing devices (also called “cursor control devices”). The output devices 1345 display images generated by the computer system 1300. The output devices 1345 include printers and display devices, such as cathode ray tubes (CRT) or liquid crystal displays (LCD). Some embodiments include devices such as touchscreens that function as both input and output devices 1340 and 1345.

Finally, as shown in FIG. 13, bus 1305 also couples computer system 1300 to a network 1365 through a network adapter (not shown). In this manner, the computer 1300 can be a part of a network of computers (such as a local area network (“LAN”), a wide area network (“WAN”), or an Intranet), or a network of networks (such as the Internet). Any or all components of computer system 1300 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method for detecting port scans in a container orchestration system cluster in a container network comprising at least a first machine executing on a host computer, the method comprising:
on the host computer:
identifying a packet stream between the first machine and a second machine operating outside of the host computer;
determining that the packet stream is potentially part of a port scanning operation based on an assessment that the packet stream comprises less than a threshold number of packets during a particular time period;
based on said determination, identifying an amount of payload data contained in the packet stream during the particular time period; and
when the identified amount of payload data is less than or equal to a threshold amount of payload data, classifying the stream as a probable port-scanning stream.

2. The method of claim 1 further comprising generating a set of data associated with packets of the packet stream received at the host computer, wherein said determining comprises using the generated data to determine that the packet stream is potentially part of a port scanning operation.

3. The method of claim 2, wherein the generated set of data comprises packet statistics regarding the packet stream.

4. The method of claim 3, wherein the packet statistics comprises at least one of packet count and size of payload of the packets of the packet stream.

5. The method of claim 4, wherein generating the set of data comprises:
creating, for the packet stream, a record to store the packet stream statistics; and
iteratively updating the record as new packets of the packet stream are received in order to update the statistics stored in the record.

6. The method of claim 1, wherein:
the first machine comprises a first pod executing on a node that executes on the host computer; and
said identifying, determining, identifying and classifying operations are performed by a port scanning sensor that is implemented in an interface of the node.

7. The method of claim 6, wherein the node comprises a virtual machine (VM) and the interface comprises a VNIC (virtual network interface card).

8. The method of claim 2, wherein the set of data for the packet stream comprises at least a first IP (Internet Protocol) address and a first port number associated with the first machine, a second IP address and a second port number associated with the second machine, and the amount of payload data exchanged between the first and second machines.

9. The method of claim 1, wherein classifying the stream as a probable port-scanning stream further comprises determining whether the stream is a probable internal port-scanning stream or a probable external port-scanning stream, wherein:
when an IP address of the second machine (i) has made more than a specified threshold number of connections to private IP addresses that are within a range of IP addresses allocated for the container orchestration system cluster or (ii) is within the range of IP addresses allocated for the container orchestration system cluster, the packet stream is classified as a probable internal port-scanning stream; and
when the IP address of the second machine (i) has made less than a specified threshold number of connections to private IP addresses that are within a range of IP addresses allocated for the container orchestration system cluster and (ii) is not within the range of IP addresses allocated for the container orchestration system cluster, the packet stream is classified as a probable external port-scanning stream.

10. The method of claim 1, wherein:
the threshold number of packets comprises a threshold number of packets exchanged in each direction; and
the assessment that the packet stream comprises less than the threshold number of packets during the particular time period further comprises an assessment that the packet stream comprises less than the threshold number of packets exchanged in each direction during the particular time period.

11. The method of claim 1, wherein determining that the packet stream is part of a port scanning operation further comprises determining that the packet stream is an invalid packet stream based on the assessment.

12. The method of claim 1, wherein the threshold amount of payload data comprises a threshold amount of bytes exchanged between the first and second machines in the packet stream in each direction during the particular time period.

13. The method of claim 12, wherein the threshold amount of bytes comprises zero bytes.

14. The method of claim 1, wherein classifying the stream comprises classifying the stream as a probable port-scanning stream when the amount of payload data sent by the first machine is more than the threshold amount and the amount of payload data sent by the second machine is less than or equal to the threshold amount.

15. The method of claim 1, wherein when the identified amount of payload data exchanged between the first and second machines in the packet stream is greater than the threshold amount of payload data, the stream is not classified as a probable port-scanning stream.

16. The method of claim 1 further comprising sending a notification regarding the classification of the packet stream to a set of one or more reporting servers, wherein the set of reporting servers send an alert identifying the probable port-scanning stream to an administrator of the container network based on the generated report.

17. A non-transitory machine readable medium storing a program for execution by a set of processing units of a host computer, the program for detecting port scans in a container orchestration system cluster comprising at least a first machine executing on the host computer, the program comprising sets of instructions for:
identifying a packet stream between the first machine and a second machine operating outside of the host computer;
determining that the packet stream is potentially part of a port scanning operation based on an assessment that the packet stream comprises less than a threshold number of packets during a particular time period;
based on said determination, identifying an amount of payload data contained in the packet stream during the particular time period; and
when the identified amount of payload data is less than or equal to a threshold amount of payload data, classifying the stream as a probable port-scanning stream.

18. The non-transitory machine readable medium of claim 17, the program further comprising a set of instructions for generating a set of data associated with packets of the packet stream received at the host computer, wherein the set of instructions for said determining comprises a set of instructions for using the generated data to determine that the packet stream is potentially part of a port scanning operation.

19. The non-transitory machine readable medium of claim 18, wherein:
the generated set of data comprises packet statistics regarding the packet stream; and
the packet statistics comprises at least one of packet count and size of payload of the packets of the packet stream.

20. The non-transitory machine readable medium of claim 19, wherein the set of instructions for generating the set of data comprises sets of instructions for:
creating, for the packet stream, a record to store the packet stream statistics; and
iteratively updating the record as new packets of the packet stream are received in order to update the statistics stored in the record.
